(19) United States
(12) Patent Application Publication
(10) Pub. No.: US 2026/0291977 A1
(43) Pub. Date: Sep. 24, 2026

(54) VISIBILITY AND MANAGEMENT OF IMPACTS OF SECURITY OBJECT COMPROMISE IN SECURITY OBJECT COMPLIANCE MANAGER

(71) Applicant: Entrust Corporation, Shakopee, MN (US)

(72) Inventors: Aleix DALMAU, Terrassa (ES); Albert FERRATE, Barcelona (ES); Tushar TAMBAY, Sunnyvale, CA (US); Michael LOGER, Garching bei Muenchen (DE); Mang Kang YONG, Concord, CA (US)

(21) Appl. No.: 19/572,419

(22) Filed: Mar. 19, 2026

Related U.S. Application Data
(60) Provisional application No. 63/868,610, filed on Aug. 22, 2025.
(60) Provisional application No. 63/775,027, filed on Mar. 20, 2025.

(51) Int. Cl. H04L 9/40

(52) U.S. Cl. CPC H04L 63/1433; H04L 63/06

(57) ABSTRACT

A security object management system operates over multiple vaults. The security object management system receives definitions of relationships that may exist between security objects contained in at least some of the vaults or among the vaults. The security object management system obtains configuration data defining relationships and inventory data. Relationships among security objects can be determined from the inventory data based on the configuration data. A blast radius is determined based on the relationships, identifying downstream risks from compromise of the security object. The blast radius can be used in determination of a risk score and management of the security objects to mitigate risk.

### CROSS-REFERENCE TO RELATED APPLICATIONS

This application claims the benefit of U.S. Provisional Application No. 63/775,027, titled “VISIBILITY AND MANAGEMENT OF IMPACTS OF SECURITY OBJECT COMPROMISE IN SECURITY OBJECT COMPLIANCE MANAGER,” filed Mar. 20, 2025, and U.S. Provisional Application No. 63/868,610, also titled “VISIBILITY AND MANAGEMENT OF IMPACTS OF SECURITY OBJECT COMPROMISE IN SECURITY OBJECT COMPLIANCE MANAGER,” filed Aug. 22, 2025, the contents of which are herein incorporated by reference in their entirety.

### BACKGROUND

Large enterprises store a wide variety of types of secure data. Such secure data is typically maintained in a secure state through use of security objects, for example, encryption keys, secrets, and certificates. Such security objects may be maintained in various secure storage locations, for example in an on-premises appliance, such as a Hardware Security Module (HSM), or within various virtual appliances like key vaults, secret vaults, or certificate storage locations either within the enterprise or within private or public cloud storage. The security objects, such as keys and secrets, may be maintained within distributed physical or virtual “vaults” throughout an enterprise. Such vaults may be distributed across an organization and represent the single control point for each respective security objects maintained in those respective vaults. The security objects can be managed by key management services (KMS) dedicated to managing particular sets of keys for particular resources. The dedicated nature of such KMSs does not allow re-use of keys or broader relationships among resources to be detected.

### SUMMARY

The present disclosure is directed to determination of relationships among security objects across different resource types and potential overall impact of compromise of a security object.

A security object compliance manager (KCM) is provided as a layer operating on top of (e.g., having a view of and access to administrative information of) multiple vaults each containing particular security objects. By being in communication with all of the various vaults, the KCM is positioned to access the properties of the security objects across different resource types, including keys from different associated resources, and various workloads from different vaults or resources associated with the keys. The KCM can scan the contents of the vaults to find defined correlations among security objects. The correlations among security objects can be used to determine the impact of compromise of a security object on other security objects, therefore allowing determination of an extent of an effect on other security objects, vaults, or secured resources that may be compromised as a result of a given security object or vault being compromised (also referred to herein as a “blast radius” of the security object or vault). The relationships including blast radius, chains of dependencies, and the like can be provided to network operators and users to improve awareness of security issues and facilitate reduction of security risks, for example by reducing or preventing re-use of particular keys, or the like. Blast radius can also be used to provide a more complete assessment of risk presented by a vault or specific security object, such as a risk score, accounting for upstream risks and downstream impacts regarding the security object.

In an embodiment, a security object compliance management system includes one or more processors and one or more memories. The one or more memories store instructions that, when executed, cause the one or more processors to obtain configuration data defining relationships among security objects, and obtain inventory data indicating use of a plurality of security objects. The inventory data includes, for each security object, a use of the security object and a secured resource associated with the security object. The instructions further cause the one or more processors to determine, based on the configuration data and the inventory data, whether a relationship exists between a first security object or secured resource and a second security object or secured resource and generate a risk metric for the first security object or vault based on at least the determined relationship. The risk metric is based on the determined relationship and indicates an extent of an effect on other security objects or secured resources that may be compromised as a result of the first security object or secured resource being compromised.

In an embodiment, a computer-implemented method for determining relationships among security objects includes obtaining inventory data indicating use of a plurality of security objects. The inventory data includes, for each security object, a use of the security object and a secured resource associated with the security object. The method further includes determining, based on the configuration data and the inventory data, whether a relationship exists between a first security object or secured resource and a second security object or secured resource and generating a risk metric for the first security object or vault based on at least the determined relationship. The risk metric is based on the determined relationship and indicates an extent of an effect on other security objects or secured resources that may be compromised as a result of the first security object or secured resource being compromised.

In an embodiment, a security object compliance management system includes one or more processors and one or more memories. The one or more memories store instructions that, when executed, cause the one or more processors to obtain configuration data defining relationships among security objects and obtain inventory data indicating use of a plurality of security objects. The inventory data includes, for each security object, a use of the security object and a secured resource associated with the security object. The instructions further cause the one or more processors to determine, based on the configuration data and the inventory data, whether a relationship exists between a first security object or secured resource and a plurality of other security objects or secured resources, determine a blast radius for the first security object or secured resource based on the determined relationships to the plurality of other security objects, and determine a risk metric for the first security object or secured resource based on the blast radius for said the first security object or secured resource. The instructions further cause the one or more processors to direct presentation of the risk metric on a display.

### BRIEF DESCRIPTION OF THE DRAWINGS

FIG. 1 shows an example enterprise environment including a security object management system.

FIG. 2 shows example logical components of a security object management system.

FIG. 3 shows an example key management interoperability protocol (KMIP) vault according to an embodiment.

FIG. 4 shows an example method for determining relationships among security objects as a microservice.

FIG. 5 shows an example method for determining relationships among security objects in an inventory service.

FIG. 6 shows an example of storage for security object relationships in an example security object compliance manager.

FIG. 7 shows an example computing environment according to an embodiment.

FIG. 8 shows an example user interface displaying a vault and risk metrics thereof.

FIG. 9 shows an example user interface displaying a risk metric for a security object.

FIG. 10 shows an example user interface displaying blast radius information for a security object.

FIG. 11 shows an example user interface providing a graphical display of relationships among vaults.

FIG. 12 shows example logical components of a security object management system performing an example method for identifying attributes and associations of publicly accessible digital assets.

### DETAILED DESCRIPTION

The present disclosure is directed to determination of relationships among security objects across different resource types and potential overall impact of compromise of a security object.

When a security object compliance manager is provided as a compliance layer for a plurality of vaults of security objects, the security object compliance manager is positioned to observe relationships among security objects in those vaults. The security object compliance manager can discover relationships among security objects and various resources, even across different workloads and for different keys and security systems.

The relationships among security objects that can be discovered by such a security object compliance manager can include the resources encrypted by a particular key, how a key is being used, whether the key is used for the encryption of multiple resources, who has access to particular keys, and the like. From these relationships, security risks associated with the security object can be assessed, including a blast radius for the security object. The blast radius is a measure of other security objects that could be compromised by the compromise of a particular security object. Blast radius can be determined based on the relationships existing among security objects. For example, where a first security object is used to encrypt a second security object, the second security object can be within the blast radius of the first security object. In some examples, one security object can have multiple security objects within its blast radius, for example when a security object is used to encrypt multiple other security objects, and/or when there is a chain of relationships among security objects such as a first security object being used to secure a second security object, which in turn is used to secure a third security object, and so on. Determination of the blast radius for security objects can allow duplicate use of keys to be reduced or eliminated, keys to be secured in accordance with their potential impact, and systems and relationships managed to promote security. Accordingly, the determination of relationships among security objects according to embodiments can improve the security of computer systems and resources included in or used thereby.

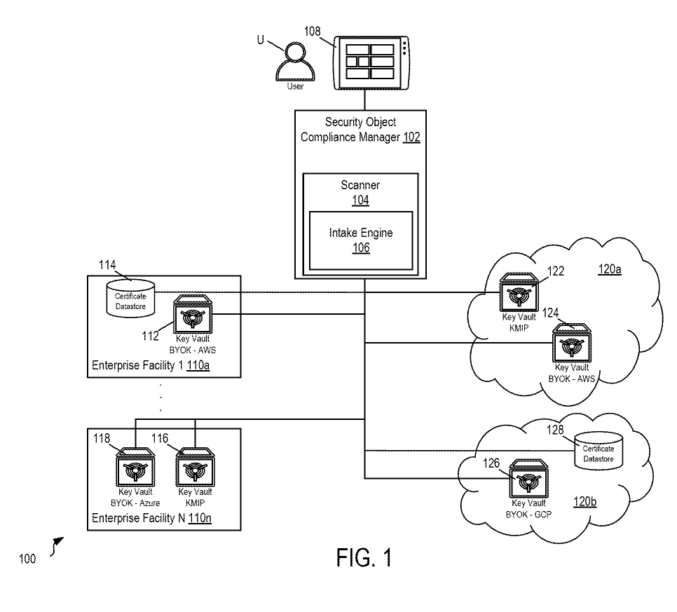

FIG. 1 shows an example enterprise environment. Enterprise environment 100 can include a security object compliance manager 102. Security object compliance manager 102 may generate and present a user interface to a user U, for example on a user device 108. In embodiments, the user interface presented to the user U includes a user interface presenting reports on usage data for security objects of the enterprise environment 100. The user device 108 may be located locally to, or remote from, the security object compliance manager 102.

Security object compliance manager 102 is a compliance layer observing the security object usage of computing resources across the enterprise environment 100. Security object compliance manager 102 may be configured to discover, and connect to, a plurality of enterprise security object storage locations. The security object compliance manager 102 can include a scanner 104 configured to scan security objects for relationships across the enterprise environment 100. In an embodiment, the security object compliance manager 102 can include an intake engine 106 configured to scan vaults or security objects during onboarding to determine the relationships among the onboarded security objects and other security objects of the enterprise environment 100.

The enterprise environment 100 can include one or more enterprise facilities 110a-n, at which various computing resources may be located. Such computing resources may include, for example, key vaults, certificates storage databases, secret vaults, and the like. Various types of key or secret vaults may be maintained at each facility. Examples of vaults can include a Key Management Interoperability Protocol (KMIP) vault, a secrets vault, infrastructure vaults, a certificate vault, a Transparent Data Encryption (TDE) key vault, a “Bring Your Own Key” (BYOK) vault. In the example shown, a first enterprise facility 110a includes a first key vault 112, as well as a certificate database 114. A second enterprise facility 110n includes two additional key vaults 116, 118. Key vaults 116, 118 are shown to be different types of key vaults, e.g., specific to various cloud security keys, local keys, and the like.

In addition to the enterprise facilities 110a-n, one or more cloud storage locations 120a-b may be included within control of an enterprise, and may host various types of security object storage locations. In the example shown, a first cloud storage location 120a includes two different key vaults 122, 124, each representing a different type of key vault (e.g., a KMIP vault and BYOK vault). A second cloud storage location 120b can include a further key vault 126, as well as a certificate data store 128. In the example shown, although the first and second cloud storage locations each maintain a BYOK vault (e.g., vaults 122, 124, 126), these key vaults may store different types of keys or workloads. In an example, keys can be associated with different cloud storage providers, such as Amazon, Google, Azure, and the like Workloads can include infrastructure objects such as virtual machines, volumes, data centers, and the like. The various vaults 112, 114, 116, 118, 122, and 124 of enterprise environment 100 can be separate vaults that are accessed separately to use the respective security objects or workloads contained therein.

Scanner 104 is configured to scan the vaults of the enterprise environment 100 such as vaults 112, 116, 118, 122, 124, or 126 to discover relationships among the security objects included therein and resources associated with said security objects. The scanner 104 can be configured to use configuration data defining relationships among security objects to scan vaults or inventory data obtained therefrom and identify the relationships among the security objects in the scanned vaults. The configuration data can include user-defined relationships among security objects. The relationships identified in the configuration data can be relationships among security objects that contribute to the blast radius thereof, for example relationships where compromise of one security object can contribute to or cause the compromise of a related security object. The configuration data can include the vault types where the respective related security objects can be stored, the types of objects in each respective vault, fields used to correlate the security objects to other security objects, and a descriptive identifier for the relationship.

In example implementations, scanner 104 can be a service or a microservice provided in security object compliance manager 102. Scanner 104 can be configured to scan any vaults of the enterprise environment or obtain security object data or summaries of the security object data from the vaults, including vaults 112, 116, and 118 included in enterprise facilities 110a-n as well as vaults 122, 124, 126 residing in cloud storage locations 120a-b. The scanner 104 can, for example, use correlation fields included in the configuration data when scanning vaults, security object data or summaries identified as containing related security objects to determine which security objects possess the defined relationships. In an embodiment, scanner 104 can receive security object summaries from the vaults. In an embodiment, the vaults provide the summaries according to a schedule, a trigger internal to the vault, or the like, without being directly prompted by the scanner 104.

In an embodiment, scanner 104 can determine immediate blast radius by the direct relationships found among the security objects. In an embodiment, scanner 104 can determine a full blast radius including chains of relationships among security objects, for example through suitable correlation fields, iterations of the scanning process, and/or processing of determined immediate blast radius information. In an embodiment, the full blast radius can be determined based on a list of possible concatenations of the immediate relationships among security objects. For example, the full concatenation of relationships from a key to a volume attached to a virtual machine can include an “encrypts” relationship between the key and the volume and an “attached_to” relationship between the volume and the virtual machine. The concatenations can be provided, for example, in the configuration data storing definitions of the relationships. For example, a particular security object may have an immediate blast radius (of resources that may be directly compromised) and a secondary or other indirect blast radius that includes resources secured using other security objects that might become compromised due to compromise of the original security object, either directly or indirectly. The results of the scan by the scanner 104 can be stored as attributes of the security object or vault, or in a suitable database such as a graph database, a relational database, or another suitable database supporting effective querying of the relationship information determined by scanner 104.

Intake engine 106 is configured to onboard vaults into being managed by security object compliance manager 102. The intake engine 106 can be configured to scan the contents of the vault being integrated to determine relationships for the security objects contained therein. The intake engine can use a configuration data to define the relationships being determined during onboarding of the vault and the security objects contained therein. The configuration data can include the vault types where the respective related security objects can be stored, the types of objects in each respective vault, fields used to correlate the security objects of the vault being onboarded to other security objects, and a descriptive identifier for the relationship. The relationships detected by intake engine 106 during onboarding of a vault can be stored as attributes of the respective security objects or vaults, or in a suitable database such as a graph database, a relational database, or another suitable database supporting effective querying of the relationship information. Optionally, scanner 104 can be used periodically or when triggered by events to update relationships detected by the intake engine 106.

User device 108 can be located locally to, or remote from, the security object compliance manager 102. User device 108 can provide a user interface, for example displaying relationships among security objects such as blast radii of the security objects, risk scores for the security objects, summary reports thereof, or the like. The user device 108 can receive inputs through the user interface, such as elements of the configuration data such as definitions of relationships, potentially related resources, the vaults containing such resources, correlation fields for security objects, and the like. The user interface of user device 108 can optionally receive inputs selecting particular vaults or security objects to view the risk scores for, and the like.

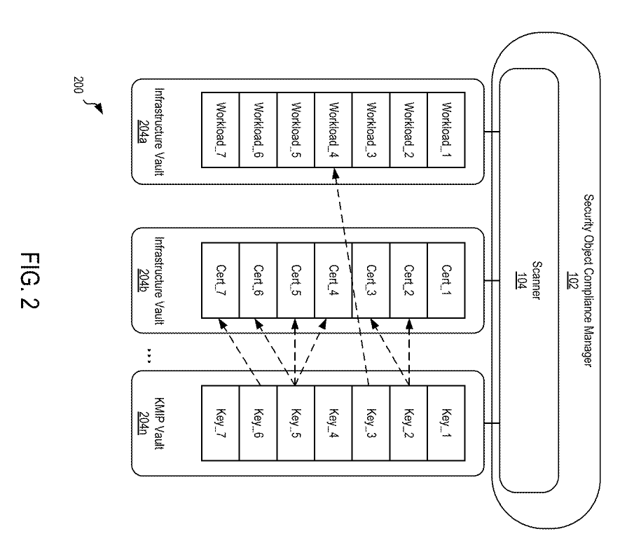

FIG. 2 shows example logical components of a security object management system. Security object management system 200 includes security object compliance manager 102 having scanner 104 and a plurality of vaults 204a-n.

Security object management system 200 can be implemented in enterprise environment 100 shown in FIG. 1 and described above. Security object compliance manager 102 is a compliance layer over the vaults 204a-n of the enterprise. Vaults 204a-n are each a repository of security objects under security object compliance manager 102. The vaults 204a-n can each store one or more different types of security objects. In an embodiment, vaults 204a-n each contain different types of security objects. In an embodiment the security objects contained in vaults 204a-n are for a plurality of resources, for example different cloud storage providers, services, and the like. The vaults 204a-n can include any vault associated with the enterprise, including vaults stored in enterprise storage and vaults contained in cloud storage. The vaults 204a-n can include a Key Management Interoperability Protocol (KMIP) vault, a secrets vault, an infrastructure vault, a certificate vault, a Transparent Data Encryption (TDE) key vault, a “Bring Your Own Key” (BYOK) vault, or the like.

In the example shown in FIG. 2, vaults 204a-n include infrastructure vaults as vault 204a and 204b, and a KMIP vault as vault 204n. The keys in the KMIP vault 204n can include keys used to encrypt certificates or workloads in the infrastructure vaults 204a and 204b. Accordingly, compromise to the keys in KMIP vault 204n could result in compromise of the keys in infrastructure vaults 204a and 204b, thus placing the infrastructure keys within the blast radius of the respective KMIP vault keys. Examples of the encryption of infrastructure keys by certain KMIP vault keys is shown in FIG. 2 by dashed lines between the related keys. The encryption of infrastructure keys by KMIP keys can be a relationship defined and labeled in a configuration data used by scanner 104, for example identifying the respective vaults 204a,b,n, fields indicative of the correlation between a KMIP key and its respective encrypted infrastructure such as virtual machines or volumes thereof, and an identifier labeling the relationship as “encrypts.” An example correlation field defining a relationship can be based on resource metadata for a cryptographic key for access to the virtual machine and a unique user identification for the KMIP symmetric key. In another example, the correlation fields can define a relationship between certification hub certificates and KMIP asymmetric keys, for example based on the public key of the KMIP asymmetric key and an identifier for the subject key included in the certification hub certificate. When scanner 104 scans the vaults 204b and 204n, the relationships among keys in the respective vaults can be detected and identified in accordance with the configuration data.

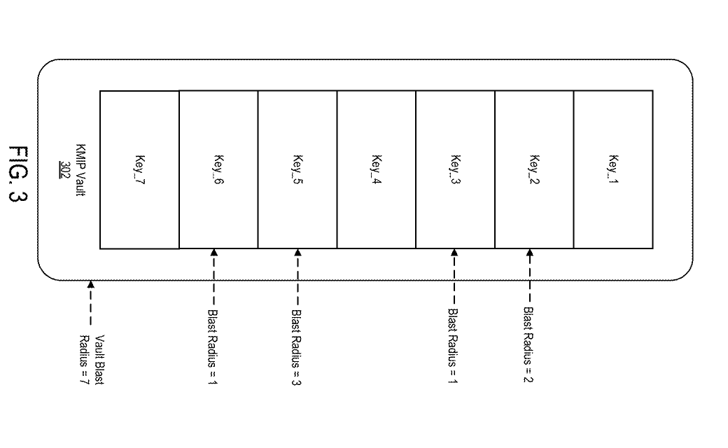

FIG. 3 shows an example key management interoperability protocol (KMIP) vault according to an embodiment. KMIP vault 302 can be the KMIP vault 204n managed by security object compliance manager 202 as described above, where the contained keys encrypt other security objects. The example KMIP vault 302 of FIG. 3 includes 7 keys, with Key 2, Key 3, Key 5, and key 6 being found to have relationships where each of the keys has a corresponding blast radius. In the example of FIG. 3, Key 2 in the KMIP vault 302 is found by the security object management system 100 to have a blast radius of two, with two security objects being compromised by compromise of Key 2. In the example of FIG. 2, Key 3 in the KMIP vault 302 is found by the security object management system 200 to have a blast radius of one, with one security object being compromised by compromise of Key 3. In the example of FIG. 3, Key 5 in the KMIP vault 302 is found by the security object management system 102 to have a blast radius of three, with three security objects being compromised by compromise of Key 5. Key 6 has a blast radius of one, with one security object being compromised by compromise of Key 6. KMIP vault 302 thus would have a blast radius of 7 associated with the vault as a whole. Each of Keys 2, 3, 5, and 6 would be associated with the respective blast radius. The blast radius values for keys 2, 3, 5 and 6 and KMIP vault 302 as a whole can be stored, for example, as attributes of the respective keys and vault, in a database for the KMIP vault 302, as entries in a database for the enterprise environment 100, or the like. Databases used to store the blast radius values can include, for example, a graph database, a relational database, or any other suitable database allowing the existence of relationships for a security object to be effectively queried, for example when determining full blast radius including chaining of relationships of objects, when calculating risk scores for selected security objects, and the like.

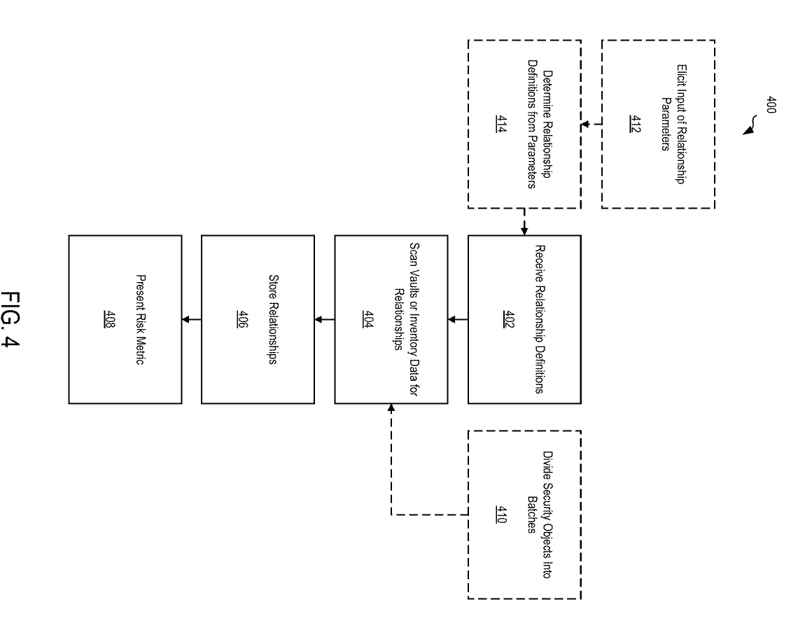

FIG. 4 shows an example method 400 for determining relationships among security objects as a service or a microservice, for example performed by scanner 104 of security object compliance manager 102. Method 400 includes receiving relationship definitions, scanning one or more vaults or inventory data thereof to identify relationships, storing identified relationships, and presenting a risk metric. Optionally, method 400 can include dividing security objects of a vault into batches. In an embodiment, method 400 can include presenting an interface eliciting input of relationship definition parameters and determining relationship definitions based on the input parameters.

In the example as illustrated, relationship definitions are received (step 402). The relationship definitions can be contained in configuration data received by the security object compliance manager 102, such as a configuration file. The configuration data can be generated based on user input of relationships among the security objects. For example, where KMIP symmetric keys are used to encrypt virtual machines (VMs), interfaces thereof, or data thereof such as volumes or disks, this relationship can be stored in the configuration data. The relationship definitions can include, for the respective security objects, the vault types where the respective related security objects can be stored, the types of objects in each respective vault, fields used to correlate the security objects to other security objects, and a descriptive identifier for the relationship. In the example where KMIP symmetric keys are used to encrypt VMs or data storage thereof such as volumes or disks, the descriptive identifier for the relationship can be, for example, “encrypts.” Other non-limiting examples of relationships that can be defined can include a relationship between an asymmetric key and a certificate, a relationship between an elastic compute cloud (EC2) instance and an elastic block store (EBS) volume, and the like. The configuration data can include custom user definitions of relationships, predefined relationship definitions such as default relationship definitions, known relationship definitions based on the setup of the infrastructure, or the like. In an embodiment, the relationship definitions can include definitions determined during onboarding of vaults by an enterprise.

One or more vaults or inventory data of one or more vaults are scanned to identify relationships (step 404). In some embodiments, the scan can be performed by a microservice implemented in scanner 104 of the security object compliance manager 102. In an embodiment, the scan at step 404 can be a scan of inventory data obtained from the one or more vaults, for example inventory data provided in an inventory push. The scan can include, for each security object in the vaults being scanned or the inventory data provided from said vaults, checking the security object for relationships as defined according to the correlation fields provided in the configuration data, and when such a correlation is detected, defining an identified relationship including the respective security objects and the descriptive identifier. The security objects can be scanned at step 404 as part of a scan of all of the security objects, one or more selected types of security objects in the vault, or a defined portion, for example as part of a batch process by scanning a batch of security objects, where defining of a batch of security objects can be performed as discussed below (e.g., at step 410). In an embodiment, filtering can be performed to determine the portion of the security objects to be scanned at step 404.

In an example embodiment, the identification of relationships at step 404 can be performed using a correlation manager to identify the possible relationships for a given security object, for example based on the configuration data. The identification of relationships can also include determining the required attributes of security objects to find a correlation therebetween. The required attributes can also be determined based on the contents of the configuration data. Based on the possible relationships and the required attributes, connectivity checks can be performed between objects that may be related. The results of the connectivity checks can confirm the existence of relationships among the security objects, with the confirmed relationships being stored as discussed below.

In the example shown, relationships identified in the scan can be stored (step 406). The relationships can be stored as an attribute for each security object, as a blast radius documentation file or database associated with the vault, in an enterprise blast radius database, combinations thereof, or the like. In an embodiment, the relationships identified by scanning of the vaults can be stored in a suitable database for the relationships, such as a graph database or a relational database. The database can be selected for efficient querying of relationships for one or both of determining full blast radii and/or for determining risk metrics.

A risk metric is presented (step 408). The risk metric can be based at least in part on the relationships identified in the scanning at step 404 and stored at step 406, such as the blast radius of the object, risk metrics for related security objects, and the like. The number of objects in the blast radius of the object can contribute to the risk metric, with a larger blast radius contributing to a higher risk score. The risk metric can be, for example, a risk score, such as a numerical risk score. The numerical score can be scaled within a defined range, for example being a number in a range from 0-25. Graphical indicia of risk can be used in addition to or in place of the risk metric, such as a graph or chart illustrating the extent of risk, an icon associated with a given risk level or range of risk scores, or the like. In an embodiment, the graphical indicia can show nodes and edges indicative of the relationships among the security objects. In an embodiment, the graphical indicia can include the relationships for multiple objects, such as a node for a vault containing security objects having respective blast radii or intermediate nodes such as at a data center associated with a plurality of security objects. In an embodiment, the risk metric presented at step 408 can include a list of elements within the blast radius. The risk metric determined at step 408 can be further based on, for example, hardware security module (HSM) protection status, sources or generation methods for keys, the age of resources, the level of documentation, the criticality of the resource, the confidentiality level of the resource, and the like. The determination of risk metrics for security objects is discussed further in U.S. Provisional Patent Application No. 63/571,250, which is herein incorporated by reference in its entirety. In an embodiment, the respective components can be weighted and combined to determine a risk score. In an embodiment, the weighting can be such that the blast radius for a given security object determined from the relationships identified at step 406 can be such that the blast radius of the security object contributes approximately 10 to 20% of the risk score for the security object. In an embodiment, the risk metric for a given security object can further be based on risk metrics for other security objects found to have relationships with a given security object or components thereof, for example how the related security objects are protected, frequency of access, risk metrics such as risk scores for the related security objects, and the like. In an embodiment, the blast radius including objects having high risk metrics can contribute to a relatively higher risk score for the security object compared to a blast radius encompassing objects having relatively lower risk metrics. The risk metric determined for the security object can be presented to a user, such as user U of user device 108, when said user views a status of the security object, a status of a vault containing the security object, a dashboard for the enterprise, or any other suitable interface for presentation of risk metrics.

Optionally, security objects of a vault can be divided into batches (step 410). The division into batches can allow the scanning of vaults at step 404 to be performed on the batches as opposed to the entire set of vaults across the enterprise. The division into batches can reduce the size of the data set being scanned in an instance of step 404 so as to use manageable sizes of data sets and reduce processing time for each respective batch. The batches obtained can each be processed, such that once each batch has been processed, the vaults of the enterprise will have been fully scanned according to step 404. The size of the batches can be selected based on the complexity of the relationships and vault contents, available computing power and memory, whether the scan is for immediate or full blast radius determinations, and the like.

In an embodiment, method 400 can include presenting an interface eliciting input of relationship definition parameters (step 412) and determining relationship definitions based on the input parameters (step 414). The input of relationship definition parameters elicited at step 412 can include some or all elements of the configuration data relating to a specific relationship among security objects, such as the vaults containing the related security objects, fields allowing correlation of the related security objects, a descriptive identifier for the relationship, and the like. In some examples, a general input of relationships and characteristics can be elicited, or the input can be guided through particular security objects or vaults. The relationship definitions can be used to determine relationship definitions at step 414, the relationship definitions being formatted for addition to the configuration data that is used in the scanning of the vaults at step 404. In an embodiment, at least some of the contents of the configuration data can be automatically filled based on the infrastructure, default definitions of relationships, or the like. In an embodiment, a chatbot can be provided to guide input of user definition of relationships. In an embodiment, the chatbot can be configured to determine and fill gaps in the set of relationships among security objects, for example based on the relationship definitions previously provided by a user.

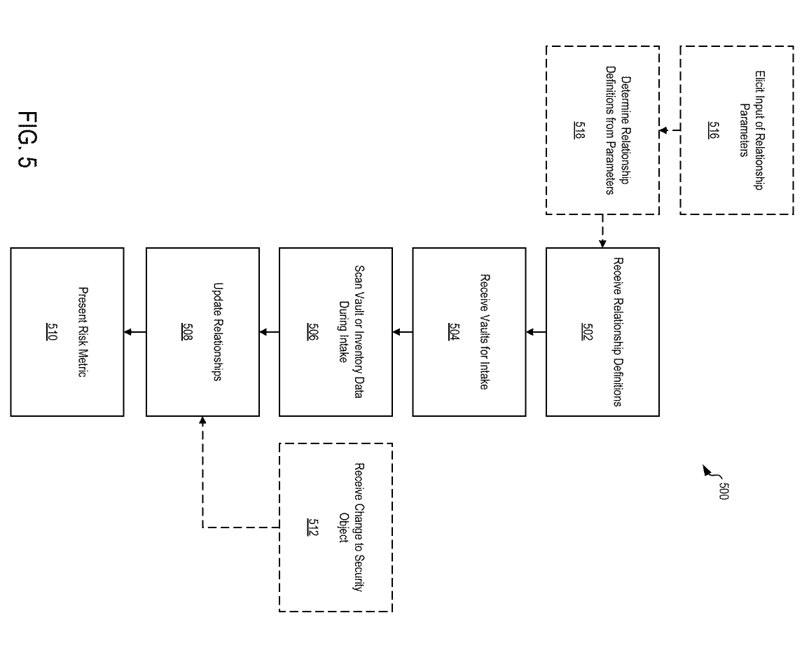

FIG. 5 shows an example method 500 for determining relationships among security objects in an inventory service. Method 500 includes receiving relationship definitions, receiving one or more vaults for intake, scanning the vault or inventory data for the vault during intake of the vault, and storing the relationships. The method 500 can further include presenting a risk metric. Optionally, the method 500 can further include receiving a change to one or more security objects and updating relationships based on the change. In an embodiment, method 500 can include presenting an interface eliciting input of relationship definition parameters and determining relationship definitions based on the input parameters.

In the example shown, relationship definitions are received (step 502). The relationship definitions can be received as configuration data, for example in a configuration file by the security object compliance manager 102. The relationship definitions can include, for the respective security objects, the vault types where the respective related security objects can be stored, the types of objects in each respective vault, fields used to correlate the security objects to other security objects, and a descriptive identifier for the relationship. In the example where KMIP symmetric keys are used to encrypt VMs, the descriptive identifier for the relationship can be, for example, “encrypts.”

One or more vaults are received for intake (step 504). The vaults received for intake can be vaults being added to the enterprise, for example as part of new cloud instances, as part of new relationships with providers, new workflows being adopted, or any other introduction of new security object vaults to the enterprise. The vaults can be received for intake by the intake engine 106 of security object compliance manager 102 as described above.

In example embodiments, one or more vaults or inventory data of the one or more vaults are scanned during intake (step 506). The scan can be performed by intake engine 106 of the security object compliance manager 102. In an embodiment, the scan can be of inventory information received from the one or more vaults. The scan can include, for each security object in the vault being onboarded or the inventory information received therefrom, checking the security object for relationships as defined according to correlation fields of the configuration data, and when such a correlation is detected, defining an identified relationship including the respective security objects and the descriptive identifier.

In example embodiments, the identified relationships are updated (step 508). The updated relationships can be stored as an attribute for each security object, as a blast radius documentation file or database associated with the vault, in an enterprise blast radius database, combinations thereof, or the like. In an embodiment, the relationships identified by scanning of the onboarded vault at step 506 can be stored in a suitable database for the relationships, such as a graph database or a relational database. The database can be selected for efficient querying of relationships for one or both of determining full blast radii and/or for determining risk metrics. An example of such a graph database is described in U.S. Provisional Application No. 63/775,020, entitled “SECURITY OBJECT VISIBILITY AND PRIVILEGE ADJUSTMENT”, filed March 20, 2025, the disclosure of which is hereby incorporated by reference in its entirety.

In the example shown, a risk metric is presented (step 510). The risk metric can be based at least in part on the relationships identified in the scanning at step 506 and stored at step 508 and presented in a user interface by the security object compliance manager 102. The risk metric can be, for example, a risk score, such as a numerical risk score. The numerical score can be scaled within a defined range, for example being a number in a range from 0-25. Graphical indicia of risk can be used in addition to or in place of the risk metric, such as a graph or chart illustrating the extent of risk, an icon associated with a given risk level or range of risk scores, or the like. In an embodiment, the graphical indicia can show nodes and edges indicative of the relationships among the security objects. In an embodiment, the graphical indicia can include the relationships for multiple objects, such as a node for a vault containing security objects having respective blast radii or intermediate nodes such as at a data center associated with a plurality of security objects. In an embodiment, the risk metric presented at step 408 can include a list of elements within the blast radius. The risk metric can be further based on, for example, hardware security module (HSM) protection status, sources or generation methods for keys, the age of resources, the level of documentation, the criticality of the resource, the confidentiality level of the resource, and the like.

In an embodiment, the respective components can be weighted and combined to determine a risk score. In an embodiment, the weighting can be such that the blast radius for a given security object determined from the relationships identified at step 506 can be such that the blast radius of the security object contributes approximately 10 to 20% of the risk score for the security object.

In an embodiment, the risk metric for a given security object can further be based on risk metrics for other security objects found to have relationships with a given security object or components thereof, for example how the related security objects are protected, frequency of access, risk scores for the related security objects, and the like. The risk metric determined for the security object can be presented to a user, such as user U of user device 108, when said user views a status of the security object, a status of a vault containing the security object, a dashboard for the enterprise, or any other suitable interface for presentation of risk metrics.

Optionally, a change to one or more security objects can be received (step 512). The change can be received, for example, by scanning security object information obtained from a sync or an inventory push from the one or more vaults. In an embodiment, timestamps can be used to determine if data has changed compared to a most recent prior update. For example, only information having timestamps following the most recent prior update can be processed to determine changes in security object relationships at step 512. In an embodiment, the change can be received by security object compliance manager 102 when the change is made to the security object. In an embodiment, the change received can trigger performance of a scan. In an embodiment, a periodic scan can be performed following receipt of the change. The scan can be a scan of security objects according to the relationship definitions received in step 502. The scan can be performed according to step 404 of method 400 as described above. In an embodiment, the scan can be performed as a batch process following division into batches, for example as described above in step 410 of method 400. The scan can determine changes to relationships that can be added to suitable attributes, databases, or the like to update the relationships (step 508). By determining the security object relationships in response to changes, current relationship information can be maintained while reducing burdens on computational resources used to scan the vaults such as scanner 104.

In some examples, changes to the one or more security objects obtained at 512 can affect risk metrics associated therewith while relationships and blast radius remain consistent. For example, the aging of security objects and other such security object characteristics can contribute to changes in the risk metrics without changes occurring in the relationships. In such examples, changes to the one or more security objects obtained at step 512 can be reflected in the risk metrics presented at step 510.

In the example shown, an interface eliciting input of relationship definition parameters can be presented (step 516). Relationship definition parameters can be determined based on the input parameters (step 518). The input of relationship definition parameters elicited at step 516 can include some or all elements of the configuration data relating to a specific relationship among security objects, such as the vaults containing the related security objects, fields allowing correlation of the related security objects, a descriptive identifier for the relationship, and the like. For example, a general input of relationships and characteristics can be elicited, or the input can be guided through particular security objects or vaults. The relationship definition parameters can be used to determine relationship definitions at step 518, the relationship definitions being formatted for addition to the configuration data that is used in the scanning of vaults during intake at step 506 and/or subsequent scans triggered by or following changes to relationships so as to update relationships at step 514.

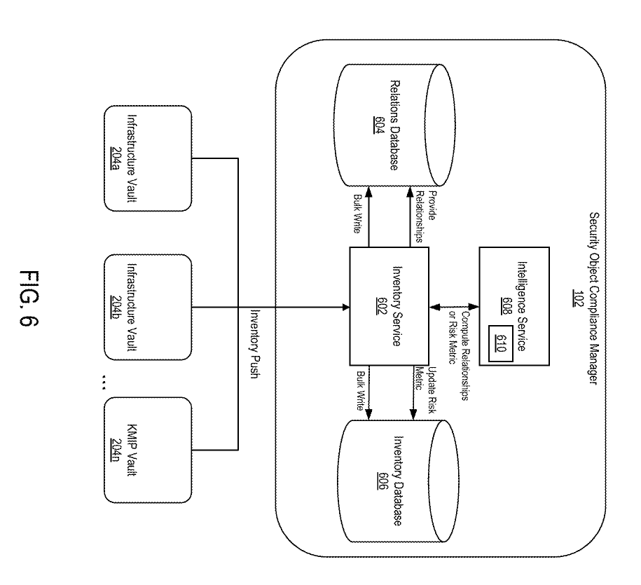

FIG. 6 shows an example of storage for security object relationships in an example security object compliance manager. The security object compliance manager 102 includes an inventory service 602, a relations database 604, and an inventory database 606. An intelligence service 608 can also be included. The intelligence service 608 can include a configuration data store 610.

In the example shown, inventory service 602 is configured to sync relationship information for security object vaults such as vaults 204a-n discussed above. The inventory service 602 can receive inventory pushes from the vaults 204a-n containing security object information. The inventory pushes can be triggered, performed at set intervals, or according to a schedule. In an embodiment, inventory pushes are made from vaults 204a-n to inventory service 602 without being directly prompted by security object compliance manager 102. In an embodiment, the inventory pushes can be prompted by security object compliance manager 102. The inventory pushes can include information regarding the security objects, for example information used in computing risk metrics or determining relationships among security objects.

The inventory service 602 can bulk write inventory push information to one or both of relations database 604 and inventory database 606. The inventory service 602 can include an intelligence service 608 configured to determine relationships among or risk metrics for the security objects based on the inventory information from one or more of the inventory pushes, the relations database 604, or the inventory database 606. The intelligence service 608 can process the provided information according to the configuration data, for example according to step 404 of the method 400, to determine relationships among the security objects or vaults, for example blast radius. The configuration data defining relationships to be determined by intelligence service 608 can be stored in a configuration data store 610, which can be included in the intelligence service 608. The relationship information determined at intelligence service 608 can be returned to inventory service 602, which can then provide the determined relationships to relations database 604 for storage. In some examples, intelligence service 608 can also be configured to determine risk metrics for the security objects or vaults. Risk metrics determined by intelligence service 608 can be written to the database entry in inventory database 606 for the corresponding security object and/or vault, and retrieved along with the other vault or security object information when requested from the inventory database 606.

In the example shown a relations database 604 is a database storing relationship information provided by inventory service 602. The relations database 604 can be a database selected based on efficiency in storage and retrieval of relationships among security objects, such as, for example, a graph database or a relational database. The relations database can be implemented in any suitable database management system (DBMS), such as Neo4j, Dgraph, NebulaGraph, or the like. In an embodiment, the relations database 604 can be an SQL database. The relations database 604 can be queried to obtain relationships between security objects stored therein, for example for computation of risk metrics, display of the relationships, or the like.

In the example shown, inventory database 606 is a database configured to store the security objects and their respective risk metrics for retrieval, for example when requested for view in a user interface. Inventory database 606 can be a database selected for ability to handle large amounts of data, such as, for example, a NoSQL database. In an embodiment, inventory database 606 can be a MongoDB database. Inventory service 602 can periodically or on trigger update the inventory database with new or changed security object identifications and/or new or changed risk metrics for the security objects. The new or changed risk metrics can include the blast radius determined by querying of the relations database 604. The new or changed risk metrics can include the blast radius explicitly as a value, or implicitly as a component of the risk metric calculated for the security object.

In an alternative embodiment, the relations database 604 can be omitted and the relationship information determined by intelligence service 608 may be included in the security object information stored in inventory database 606. In such embodiments, a materialized view can be prepared in the inventory database based on, for example, last updated timestamps for entries to update blast radius information incrementally and only when necessitated by changes to the security keys.

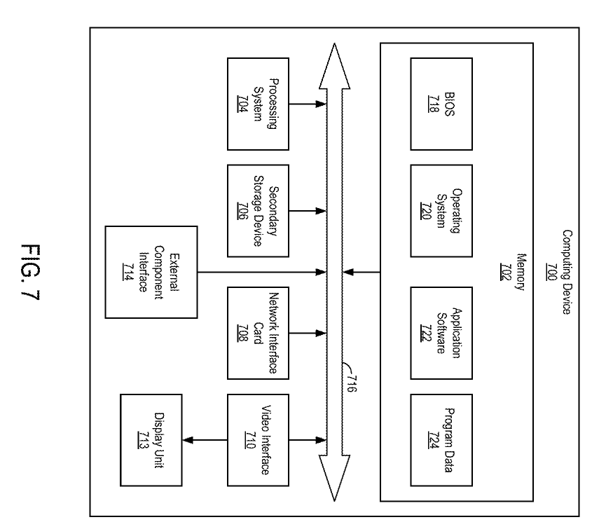

FIG. 7 illustrates an example computing device 700 on which aspects of the present disclosure may be implemented. The computing device 700 can be used, for example, to implement computing devices such as the centralized compliance platform 102, the user device 108, or various enterprise hardware used to implement the security object storage locations described herein.

In the example of FIG. 7, the computing device 700 includes a memory 702, a processing system 704, a secondary storage device 706, a network interface card 708, a video interface 710, a display unit 713, an external component interface 714, and a communication medium 716. The memory 702 includes one or more computer storage media capable of storing data and/or instructions. In different embodiments, the memory 702 is implemented in different ways. For example, the memory 702 can be implemented using various types of computer storage media, and generally includes at least some tangible media. In some embodiments, the memory 702 is implemented using entirely non-transitory media.

The processing system 704 includes one or more processing units, or programmable circuits. A processing unit is a physical device or article of manufacture comprising one or more integrated circuits that selectively execute software instructions. In various embodiments, the processing system 704 is implemented in various ways. For example, the processing system 704 can be implemented as one or more physical or logical processing cores. In another example, the processing system 704 can include one or more separate microprocessors. In yet another example embodiment, the processing system 704 can include an application-specific integrated circuit (ASIC) that provides specific functionality. In yet another example, the processing system 704 provides specific functionality by using an ASIC and by executing computer-executable instructions.

The secondary storage device 706 includes one or more computer storage media. The secondary storage device 706 stores data and software instructions not directly accessible by the processing system 704. In other words, the processing system 704 performs an I/O operation to retrieve data and/or software instructions from the secondary storage device 706. In various embodiments, the secondary storage device 706 includes various types of computer storage media. For example, the secondary storage device 706 can include one or more magnetic disks, magnetic tape drives, optical discs, solid-state memory devices, and/or other types of tangible computer storage media.

The network interface card 708 enables the computing device 700 to send data to and receive data from a communication network. In different embodiments, the network interface card 708 is implemented in different ways. For example, the network interface card 708 can be implemented as an Ethernet interface, a fiber optic network interface, a wireless network interface (e.g., WiFi, WiMax, Bluetooth, etc.), or another type of network interface.

In optional embodiments where the video interface 710 is included in the computing device 700, the video interface 710 enables the computing device 700 to output video information to the display unit 713. The display unit 713 can be various types of devices for displaying video information, such as an LCD display panel, a plasma screen display panel, a touch-sensitive display panel, an LED or OLED screen, a cathode-ray tube display, or a projector. The video interface 710 can communicate with the display unit 713 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 714 enables the computing device 700 to communicate with external devices. For example, the external component interface 714 can be a USB interface and/or another type of interface that enables the computing device 700 to communicate with external devices or peripheral devices integrated within the same housing (e.g., in the case of mobile devices). In various embodiments, the external component interface 714 enables the computing device 700 to communicate with various external components, such as external storage devices, input devices, speakers, modems, media player docks, other computing devices, scanners, digital cameras, and fingerprint readers.

The communication medium 716 facilitates communication among the hardware components of the computing device 700. The communications medium 716 facilitates communication among the memory 702, the processing system 704, the secondary storage device 706, the network interface card 708, the video interface 710, and the external component interface 714. The communications medium 716 can be implemented in various ways. For example, the communication medium 716 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 702 stores various types of data and/or software instructions. The memory 702 stores a Basic Input/Output System (BIOS) 718 and an operating system 720. The BIOS 718 includes a set of computer-executable instructions that, when executed by the processing system 704, cause the computing device 700 to boot up. The operating system 720 includes a set of computer-executable instructions that, when executed by the processing system 704, cause the computing device 700 to provide an operating system that coordinates the activities and sharing of resources of the computing device 700. Furthermore, the memory 702 stores application software 722. The application software 722 includes computer-executable instructions, that when executed by the processing system 704, cause the computing device 700 to provide one or more applications. The memory 702 also stores program data 724. The program data 724 is data used by programs that execute on the computing device 700.

Although particular features are discussed herein as included within an electronic computing device 700, it is recognized that in certain embodiments not all such components or features may be included within a computing device executing according to the methods and systems of the present disclosure. Furthermore, different types of hardware and/or software systems could be incorporated into such an electronic computing device.

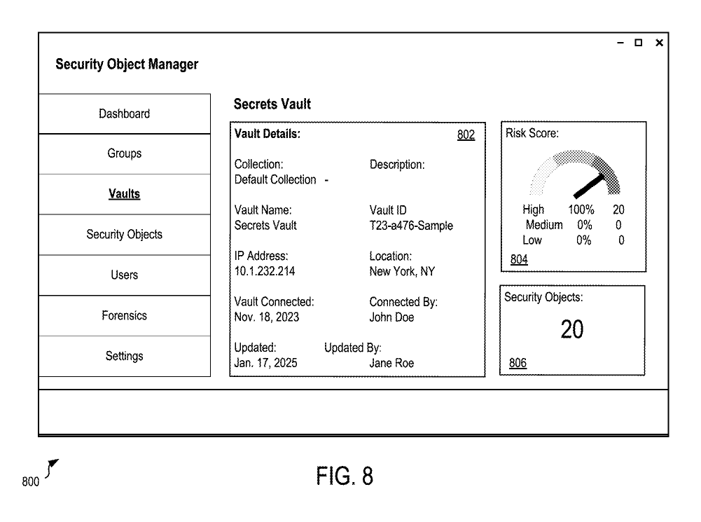

FIG. 8 shows an example user interface displaying a vault and risk metrics thereof. User interface 800 shows information regarding a vault such as, in the example shown in FIG. 8, a secrets vault. The user interface 800 includes vault details 802, risk metric overview 804, and a raw number of security objects 806. The vault details 802 can include the collection, description, name, identifier, IP address, location, and dates of creation, connection, updating, or synchronizing of the vault. A user who has connected or updated the vault can also be included in vault details 802.

The risk metric overview 804 can provide a representation of the overall risk presented by the vault, along with classification of the contained security objects into particular risk tiers. The representation of overall risk can be, for example, a showing that the average risk metric of the security objects of the vault indicate high, medium, or low risk. The average risk metric can be, for example, a mean or a weighted average of the risk metrics for each security object of the vault, such as a risk score. The risk metric information for the security objects within the vault can be determined according to, for example, step 408 of method 400 or step 510 of method 500 as described above and shown in FIGS. 4 and 5, respectively. The overall risk being low, medium, or high can be determined based on comparison of the average risk metric with ranges associated with the respective risk levels.

The risk metric overview 804 can additionally include indication of the numbers of security objects within each of the respective risk levels based on the individual risk metric of each respective security object. As can be seen in the example of FIG. 8, the secrets vault being displayed in user interface 800 includes 20 security objects. Each of the 20 security objects shown in the raw number of security objects 806 is high risk according to the classifications of the contained security objects provided in risk metric overview 804. This in turn can result in the vault as a whole being classified as high risk as also visible in risk metric overview 804.

In examples, user interface 800 can provide a user with a view of enterprise-wide risks associated with the vault being viewed. By including blast radius into the determination of risk scores for a vault, downstream consequences of compromise can be seen, and users can take remedial actions such as reducing duplicate usage of keys, changing processes to modify relationships among security objects and the like. Such remedial actions can reduce the blast radius of particular security objects or vaults, thereby reducing potential security impacts. The reduction of blast radius for particular security objects or vaults can be seen in reduced risk scores in the user interface 800 following such remedial actions.

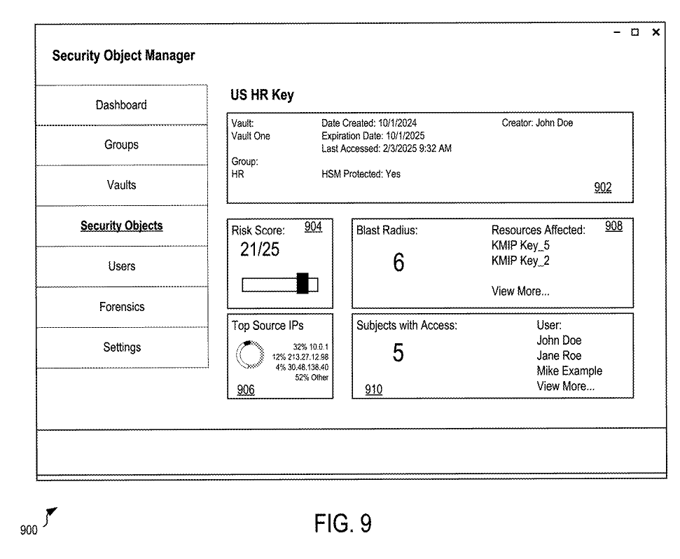

FIG. 9 shows an example user interface displaying a risk metric for a security object. User interface 900 is a user interface showing details for a specific security object. In the example shown in FIG. 9, the security object is an HR key. The security object view presented in user interface 900 includes object details 902, risk score 904, source IPs 906, blast radius summary 908, and subjects with access 910.

The object details 902 can include, for example, a vault containing the security object, a group the security object belongs to, dates of creation, expiration and/or most recent access, an identification of the creator of the resource, and other such general information regarding the characteristics and/or use of the security object. The risk metric 904 is an overall risk metric for the security object being displayed in user interface 900. The risk metric can be, for example, a risk score grading the risk associated with the security object on a numerical scale, for example 0-25. The risk metric can be determined as discussed above with respect to steps 408 and 510 of methods 400 and 500, respectively. The risk metric can be based on, for example, hardware security module (HSM) protection status, sources or generation methods for keys, the age of resources, the level of documentation, the criticality of the resource, the confidentiality level of the resource, and the like, along with a blast radius of the security object.

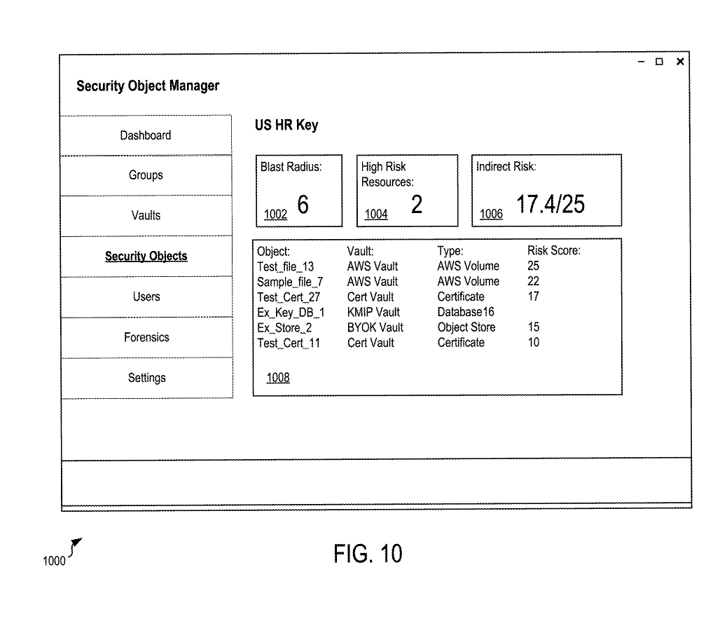

The source IPs 906 can provide a view of the IP addresses used to access the security object. The subjects with access 910 can provide at least a partial list of users having roles, privileges, or the like allowing those users access to the security object. In an embodiment, the subjects with access 910 can further show a number of times the users have accessed the security object. In an embodiment, the subjects with access 910 can include a display of subjects who have not accessed the security object. The blast radius summary 908 can include a number of security objects within the blast radius of the security object presently being viewed in the user interface 900, along with at least a partial list of the security objects within the blast radius. In an embodiment, interaction with the blast radius summary 908 or a portion thereof can bring the user to a user interface displaying further blast radius information for the security object, for example as shown in FIG. 10 and described below.

FIG. 10 shows an example user interface displaying blast radius information for a security object. User interface 1000 is a user interface showing the blast radius and resulting risk associated with one security object, for example the HR key in the examples shown in FIGS. 9 and 10. The blast radius window for the security object is shown, which includes a blast radius 1002, high risk resources 1004, and indirect risk 1006. The user interface 1000 can further include a list 1008 of the workloads or security objects within the blast radius.

In example implementations, the user interface 1000 can be provided to a user such as user U through user device 108. The user interface 1000 can integrate risk metric information and blast radius specific information. The risk metric information can be determined according to, for example, step 408 of method 400 or step 510 of method 500 as described above and shown in FIGS. 4 and 5, respectively. The blast radius 1002 can be a total number of associated workloads or security objects, without regard to the risk scores thereof. The high-risk resources 1004 can provide an indication of the number of associated workloads or security objects in the blast radius that possess a high risk score themselves. High risk resources 1004 can provide insight into the largest potential risks within the blast radius of the security object being viewed. The indirect risk 1006 can provide an average risk score of the workloads or security objects within the blast radius of the security object being viewed in user interface 1000. Indirect risk 1006 can show a mean, a weighted average, or any other indication of the risk levels for the full set of workloads or security objects within the blast radius of the security object being viewed in user interface 1000. A list 1008 of the workloads or security objects in the blast radius of the security object can be presented in the user interface 1000. The list 1008 can include the name of each respective object, identification of the vault containing the object, and the risk score for the object. Additional information, such as the type of object, vendor associated with the object, collection containing the object, and the like can further be introduced.

In examples, the user interface 1000 can provide a user with blast radius information specific to a security object and accompanied by the risks associated with objects within the blast radius. Such information can allow a user to make changes to the relationships or usage of the security object, for example, reducing duplicate uses of keys or the like so as to reduce the blast radius of the security object. The reduction of the blast radius can be made so as to remove the security object(s) presenting the highest indirect risk from the blast radius. In an example, the blast radius information can inform decisions regarding how to secure the object in line with the potential impact of compromise. This can allow security of systems and enterprise environments to be improved.

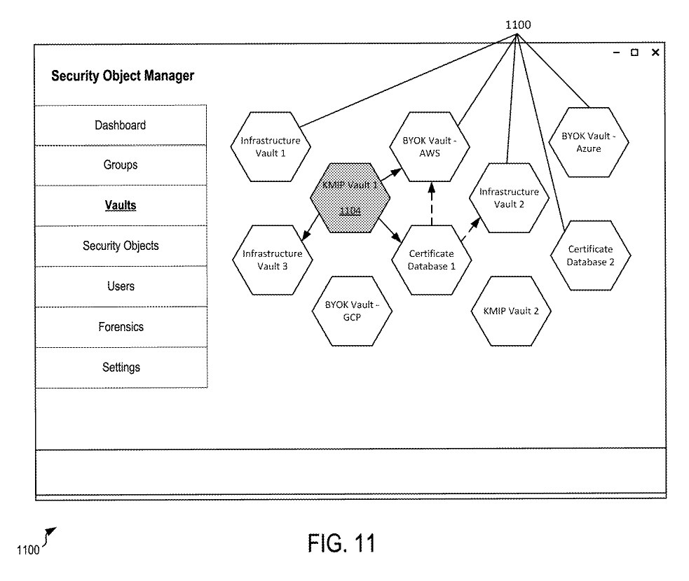

FIG. 11 shows an example user interface providing a graphical display of relationships among vaults. In user interface 1100, vaults 1102 are represented as a series of hexagons in an array. A selected vault 1104, for example selected through hovering over or clicking on the respective vault is highlighted, and arrows are provided linking selected vault 1104 to vaults 1102 having relationships with the selected vault 1104. In an embodiment, further arrows can be provided to show further relationships, such as upstream or downstream relationships of vaults 1102 having relationships with the selected vault 1104. The arrows can show the directionality of relationships.

The user interface 1100 can provide visualization of the relationships among security objects across various vaults of an enterprise. The information provided in user interface 1100 can provide a high level overview of the vaults and relationships of the security objects contained therein, allowing the vaults and relationships to be quickly and intuitively understood by users.

Conventional certificate lifecycle management solutions primarily manage the operational state of individual certificates (e.g., tracking issuance, expiration, renewal, and revocation). This asset-centric view is generally incapable of representing or querying the complex associations that exist between certificates and between certificates and other cryptographic assets. For example, a conventional certificate lifecycle management tool can report that a certificate is nearing expiration, but may not easily identify all other certificates, regardless of issuer or subject, that share the same public key, a critical indicator of potential key compromise or poor security hygiene.

This siloed approach to certificate management leads to visibility gaps and generally fails to provide users with a view of associations of publicly available digital assets. Certificates procured by different teams or embedded in specific applications can become untracked and unmanaged until their unexpected expiration causes a service outage or their compromise leads to a security breach. Lacking a unified data model, these conventional systems cannot provide a single, authoritative inventory across all internal and external sources. Consequently, any attempt to correlate data, for instance, to determine if a certificate for an internal, non-public service has been erroneously published to a public certificate transparency (CT) log, becomes a manual, resource-intensive, and error-prone process that is infeasible to perform at enterprise scale.

The unique characteristics of CT logs present further technical challenges that conventional systems are ill-equipped to handle. The immense data volume and high velocity of certificate issuance place an unsustainable strain on traditional database technologies. Furthermore, CT logs are essentially chronological ledgers, lacking the semantic structure needed for sophisticated relationship analysis; they present a flat, unstructured view of the certificate ecosystem. This very transparency creates a security paradox: it enhances security by making CA actions public but simultaneously introduces new risks by exposing internal hostnames and infrastructure details that can be harvested by attackers for reconnaissance. Conventional, siloed systems are incapable of resolving this paradox. An internal PKI is blind to the public CT log ecosystem, and external monitoring tools are unaware of which enterprise assets are intended to be private. As a result, these systems cannot correlate the public disclosure of an internal-only certificate with an internal asset inventory to flag a potential misconfiguration or breach, leaving the information leakage risk unmitigated.

In embodiments, a security object compliance manager is provided as a compliance layer configured to connect to and retrieve data from a plurality of heterogeneous data sources, including a certificate transparency (CT) log database. The security object compliance manager can discover attributes and associations of certificates, allowing for complex, relationship-based queries that can traverse publicly available asset data and assets managed by the security object compliance manager, revealing patterns and risks that span multiple vaults and asset types. For example, the security object compliance manager can run compliance, compute risk score(s), and add documentation to discovered certificates and domains from CT Logs.

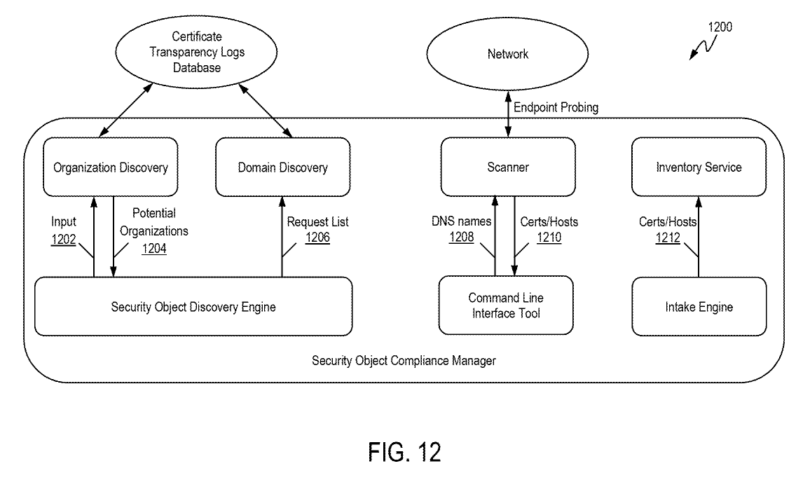

FIG. 12 shows example logical components of a security object management system performing an example method 1200 for identifying attributes and associations of publicly accessible digital assets. The security object management system can be implemented, for example, in enterprise environment 100 shown in FIG. 1 and described above. The security object compliance manager is a compliance layer over vaults of an enterprise configured to discover, and connect to, a plurality of security object storage locations including, for example, a certificate transparency (CT) logs database. The security object compliance manager is configured to generate and present a plurality of user interfaces, including, for example a security object discovery UI associated with the security object discovery engine and a security object management UI associated with the inventory service.

As illustrated, method 1200 provides an example process for identifying publicly accessible digital assets associated with a given organization by leveraging Certificate Transparency (CT) logs. At 1202-1204, method 1200 includes the security object discovery engine performing organization discovery and domain discovery.

At 1202, the security discovery engine receives input (e.g., user input through the security object discovery engine or an automated query) of an entity including an attribute associated with a target organization. For example, the security object discovery UI allows users to input the name of an organization of interest. The security object discovery engine then searches a CT logs database based on the input.

In examples, the CT logs database is an internally maintained CT Logs database, that is indexed and synchronized with live CT log sources. The security object compliance manager searches the index database for certificates associated with the input. A certificate may be considered associated with the input if, for example, an organization field of the certificate contains a provided input string.

At 1204, the security discovery engine provides a list of organization names from any certificates associated with the input. The list of organization names can allow users to select relevant (i.e., intended) organizations, filtering out unrelated entries. For example, a user may be interested in an organization named “Orange” and selection from the list of organization names can allow the user to exclude similarly named organizations, such as “Big Oranges LLC,” or include related companies (e.g., subsidiaries), such as “Orange LLC” and “Orange GmbH.”

At 1206, method 1200 includes performing domain discovery. In examples, domain discovery can be automatically performed once organization(s) are determined (e.g., the organizations are selected through the security object discovery UI). During domain discovery, the security object compliance manager extracts all domain names found in the Subject and Subject Alternative Name (SAN) fields of the associated certificates. These domains can be compiled into a hostnames file. In examples, operation 1206 can be configured to return all the actual certificates from the CT logs (e.g., instead of returning the hostnames only).

As illustrated, the security object compliance manager includes a scanner configured to probe reachable endpoints over a network (e.g., the internet). At 1208-1210, method 1200 includes performing a scan of endpoints associated with the requested organization(s).

At 1208, a command line interface tool provides the scanner with domains of interest (e.g., domains returned from operation 1206). In some instances, scanning is based on a hostnames file generated as part of domain discovery. For example, the hostnames file can be sent to a probing script that attempts to connect to each domain on port 443. For each reachable endpoint, the script collects the IP address, port, server certificate, and reachability status.

At 1210, the scanner returns a collected dataset associated with the domains of interest. The collected dataset can include, for example, one or more of verified hostnames, IPs, ports, and certificates. In examples, the collected data set is returned to the user through the security object discovery engine.

At 1212, an intake engine uploads the scan output to an inventory service of the security object compliance manager (e.g., as a new data source).

The intake engine is configured to define relationships between the certificates and other security objects contained within vaults managed by the security compliance manager. Relationships may be determined based on attributes of the certificate or predefined policies of the security compliance manager. For example, a relationship can be defined between a certificate and a key used to create the certificate. The relationships detected by the intake engine can be stored as attributes of the respective certificates, security objects, or vaults, or in a suitable database such as a graph database, a relational database, or another suitable database supporting effective querying of the relationship information.

In examples, the intake engine performs multiple calls to an inventory service to create the assets in one data source. Once ingested, the security object compliance manager’s capabilities such as risk scoring, compliance checks, and asset inventory, can be applied to the discovered assets, enabling organizations to monitor and manage their external digital footprint based on publicly available CT log data.

Accordingly, method 1200 allows users to understand how each certificate of an organization of interest contributes individually and interconnects with other security objects. The security object compliance manager can present a unified dashboard for fine-grained visibility of certificate insights. These insights can include, for example, what key was used to create a certificate, whether a key was used to create more than one certificate, what the trust chain to a root certificate authority is for an end-to-end certificate (e.g., whether cross-signing is present or an intermediate certificate authority is expired), and what resource(s) a key is protecting.

In examples, method 1200 allows users to discover insights about organizations of interest, including what certificate issuers the organization is using and the average age of the certificates associated with the organization.

In examples, compliance can be run on the certificates of the requested organization even if the requested organization’s certificates are not scanned or managed by the security object compliance manager (since CT logs databases are public). In some such cases, the security object compliance manager may not be aware of whether the certificates returned are in use.

In examples, probing or scanning publicly available endpoints of a company may require the company’s consent. An external party may consent to having a scan of their network performed, for example as part of an audit. In such instances, the security object compliance manager can provide insight services across organizations. In other instances, organizations can use the security object compliance manager to perform an audit of their own digital footprint exposed to the public internet.

Current public-key algorithms, like RSA and ECC, rely on mathematical problems that quantum computers could potentially solve efficiently, making them vulnerable. Although there is no viable Quantum computer in existence today, quantum computers could one day decrypt sensitive data protected by today’s public key infrastructure. Therefore, there is a need for organizations that use digital certificates for authentication, secure communication, code signing, or data integrity to efficiently assess the risk posed by their cryptographic assets.

Embodiments of the present disclosure allow for dynamic, automated insights of the quantum readiness of an organization by assigning a quantum risk score for each cryptographic asset, including certificates, cryptographic keys, and secrets. For example, the security object compliance manager can provide organizations with a quantum risk score for a certificate (and its chain), allowing the organization to identify high-risk certificates (e.g., RSA-2048), understand which systems are most vulnerable in a post quantum environment, and prioritize remediation efforts.

The centralized inventory of cryptographic assets and the ability to annotate each object through a flexible documentation mechanism allows the security object compliance manager to determine post-quantum readiness of cryptographic assets that may not be evident from the metadata of the assets. For example, through the security object compliance manager asset owners can document how difficult it is to revoke a certificate or assess the value of a resource protected by a specific key. Embodiments of the present disclosure extend these documentation insights to assess risk and proactively safeguard systems against emerging quantum threats.

In examples, a quantum risk score quantifies how vulnerable a cryptographic asset, such as a key or certificate, is to quantum computing attacks, particularly those that could break classical cryptographic algorithms like RSA and ECC. By maintaining a centralized inventory of cryptographic assets and assigning a quantitative post quantum score to each asset, the security object compliance manager can provide reports to an organization that identify the highest risk assets or suggest remediation efforts.

In some instances, the security object compliance manager maintains a centralized, continuously updated inventory of metadata describing cryptographic assets. This metadata can include key attributes including, for example, algorithm type, key length, owner, expiration date, and other relevant properties. In addition, the security object compliance manager provides tools for organizations to document each asset by adding contextual information that may not be automatically detectable (e.g., inherent to the asset). Examples of such documentation can include, for example, the criticality of the asset, whether the asset protects sensitive information, and the difficulty of revoking a certificate associated with the asset.

In examples, the security object compliance manager derives a set of properties for each asset based on metadata and organization-provided documentation. These properties are then used by the security object compliance manager to calculate a quantum risk score. In some instances, if the asset uses a Post-Quantum Cryptography (PQC) algorithm the asset is given a quantum risk score of 0. Otherwise, the quantum risk score is calculated as the sum of individual scores assigned to each property based on its risk level.

A quantum risk assessment can be based on one or more of the following properties: public key algorithm (e.g., RSA, ECC, PQC), signature algorithm (e.g., the algorithm used to sign a certificate, such as SHA-256 with RSA), validity period (the duration for which the certificate is valid), key length, cumulative certificate chain strength, cryptographic library used to generate or manage the certificate, intended use of the certificate (e.g., TLS, code signing, VPN), revocation difficulty, data sensitivity, exposure level (e.g., how publicly accessible the certificate is), and longevity of trust (e.g., how long the certificate or its signature must remain secure).

These properties form the foundation of a composite scoring model. The security object compliance manager incorporates this model to provide automated, context-aware quantum risk scoring that supports proactive cryptographic modernization and aligns with post-quantum readiness guidance.

Optionally, the security object compliance manager can assign weights to properties to characterize the relative impact. In examples, a weight is assigned by default to each property and administrative users for an organization can update the weights according to their priorities. For example, the public key algorithm can be 30 percent, the chain strength can be 20 percent, data sensitivity can be 15 percent, and other properties can collectively be 35 percent (e.g., 5 to 10 percent each) of the overall risk score.

In examples, the assessment model avoids averaging the total score of properties. Refraining from averaging individual property scores allows for more granularity (e.g., retaining the full impact of each property), easier weighting (e.g., custom weights may be applied without concern for rescaling), and raw property scores can be used for internal prioritization or dashboards.

In examples, the quantum risk score can be normalized to a scale. For example, after combining the risks of each considered property the combined score can be normalized to a 0-25 scale, where normalized values of 0 to 5 inclusive represent a low risk (e.g., quantum-ready), normalized values of 6 to 15 inclusive represent a medium risk (e.g., needs planning), and normalized values of 16 to 25 inclusive represent a high risk (e.g., urgent migration needed).

In examples, certificates can be assigned quantum readiness scores to help organizations prioritize high-risk certificates and plan phased migrations based on real-time insights. Because a certificate is only as secure as the weakest link in its trust chain, the quantum readiness risk assessment can consider the entire certificate chain, including weak links, when determining the cryptographic exposure. For example, a certificate chain can include a leaf certificate (e.g., for a website or service), intermediate certificate(s) (e.g., issued by a CA), and a root certificate (e.g., trusted by the operating system or browser). In such examples, each certificate in the chain can be assigned a quantum risk profile.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

What is claimed is:

1. A security object compliance management system, comprising:
one or more processors; and
one or more memories, wherein the one or more memories store instructions that, when executed, cause the one or more processors to:
obtain configuration data defining relationships among security objects;
obtain inventory data indicating use of a plurality of security objects, wherein the inventory data includes, for each security object, a use of the security object and a secured resource associated with the security object;
determine, based on the configuration data and the inventory data, whether a relationship exists between a first security object or secured resource and a second security object or secured resource; and
generate a risk metric for the first security object or vault based on at least the determined relationship, wherein the risk metric is based on the determined relationship and indicates an extent of an effect on other security objects or secured resources that may be compromised as a result of the first security object or secured resource being compromised.

2. The security object compliance management system of claim 1, wherein the security objects are stored in a plurality of vaults, each vault of the plurality of vaults containing a different type of security object from other vaults of the plurality of vaults, wherein the type of security object is one of keys, secrets, or certificates.

3. The security object compliance management system of claim 1, wherein the plurality of security objects includes security objects associated with a plurality of different secured resources.

4. The security object compliance management system of claim 1, wherein the instructions further cause the one or more processors to direct display of a user interface prompting input of parameters of the configuration data.

5. The security object compliance management system of claim 1, wherein the instructions cause the one or more processors to obtain the inventory data by a microservice receiving inventory data for each security object of the plurality of security objects.

6. The security object compliance management system of claim 5, wherein the microservice divides the plurality of security objects into a plurality of batches.

7. The security object compliance management system of claim 1, wherein the instructions cause the one or more processors to obtain the inventory data during an onboarding of the vault into the security object compliance management system.

8. The security object compliance management system of claim 7, wherein the instructions further cause the one or more processors to receive a change in the inventory data for one or more security objects, identify one or more of the relationships defined in the configuration data affected by said change, and update the risk metric for said one or more security objects affected by said change.

9. The security object compliance management system of claim 1, wherein the identified relationships are stored in a graph database.

10. The security object compliance management system of claim 1, wherein the instructions further cause the one or more processors to present the risk metric, and presenting the risk metric includes display of a list of security objects identified as having relationships with the first security object or vault.

11. A computer-implemented method for determining relationships among security objects, comprising:
obtaining inventory data indicating use of a plurality of security objects, wherein the inventory data includes, for each security object, a use of the security object and a secured resource associated with the security object;
determining, based on the configuration data and the inventory data, whether a relationship exists between a first security object or secured resource and a second security object or secured resource; and
generating a risk metric for the first security object or vault based on at least the determined relationship, wherein the risk metric is based on the determined relationship and indicates an extent of an effect on other security objects or secured resources that may be compromised as a result of the first security object or secured resource being compromised.

12. The method of claim 11, further comprising presenting the risk metric, wherein the presenting of the risk metric includes displaying a list of security objects identified as having relationships with the first security object or vault.

13. The method of claim 12, wherein the plurality of security objects are stored in a plurality of vaults, and each vault of the plurality of vaults contains a different type of security object from other vaults of the plurality of vaults.

14. The method of claim 11, wherein security objects of the plurality of security objects are associated with a plurality of different secured resources.

15. The method of claim 11, further comprising directing display of a user interface prompting input of parameters of the configuration data, and generating the configuration data based on input of the parameters at the user interface.

16. The method of claim 11, wherein obtaining the inventory data includes a microservice receiving data associated with each security object of at least one of the plurality of security objects.

17. The method of claim 16, further comprising the microservice dividing the plurality of security objects into a plurality of batches.

18. The method of claim 11, wherein obtaining the inventory information includes receiving data associated with the plurality of security objects during an onboarding of a vault into the security object compliance management system.

19. The method of claim 18, further comprising receiving a change in the inventory data for one or more security objects, identifying one or more of the relationships defined in the configuration data affected by said change, and updating the risk metric for said one or more security objects affected by said change.

20. A security object compliance management system, comprising:
one or more processors; and
one or more memories, wherein the one or more memories store instructions that, when executed, cause the one or more processors to:
obtain configuration data defining relationships among security objects;
obtain inventory data indicating use of a plurality of security objects, wherein the inventory data includes, for each security object, a use of the security object and a secured resource associated with the security object;
determine, based on the configuration data and the inventory data, whether a relationship exists between a first security object or secured resource and a plurality of other security objects or secured resources;
determine a blast radius for the first security object or secured resource based on the determined relationships to the plurality of other security objects;
determine a risk metric for the first security object or secured resource based on the blast radius for said the first security object or secured resource; and
direct presentation of the risk metric on a display.
